(19) United States
(12) Patent Application Publication
(10) Pub. No.: US 2021/0301990 A1
(43) Pub. Date: Sep. 30, 2021

(54) LIGHT FIXTURE MOUNT AND METHOD OF INSTALLATION

(71) Applicant: Katerra Inc., Menlo Park, CA (US)

(72) Inventors: Douglas McCabe, Sacramento, CA (US); James Sweeney, Sacramento, CA (US); Andy Colborn, Sacramento, CA (US); Jumie Yuventi, Menlo Park, CA (US)

(73) Assignee: Katerra Inc., Menlo Park, CA (US)

(21) Appl. No.: 17/218,572

(22) Filed: Mar. 31, 2021

Related U.S. Application Data
(60) Provisional application No. 63/002,497, filed on Mar. 31, 2020.

(51) Int. Cl. F21S 8/02; F21V 23/00; F21V 21/04

(52) U.S. Cl. CPC F21S 8/026; F21V 21/049; F21V 21/047; F21V 23/001

(57) ABSTRACT

A light fixture mount is provided. The recessed light includes a junction box, a cable, a plurality of screws, and a mounting plate. The mounting plate includes a circular perforation, an alignment hole, at least one slot, and a plurality of holes spaced parallel to the at least one slot. The alignment hole is centered within the circular perforation. The at least one slot is configured to receive a first shank of a first fastener. The at least one slot has a width less than a first diameter of a first head of the first fastener. The plurality of holes is configured to receive a second shank of a second fastener. The plurality of holes has a second diameter that is less than a third diameter of a second head of the second fastener. A method of mounting the light fixture mount is also provided.

### CROSS REFERENCE TO RELATED APPLICATION

This application claims the benefit of U.S. Provisional Application No. 63/002,497 for LIGHT FIXTURE MOUNT AND METHOD OF INSTALLATION filed on Mar. 31, 2020, which is incorporated by reference as if fully set forth.

### FIELD OF INVENTION

The invention relates generally to installation of lighting fixtures, more specifically the invention relates to a light fixture mount and a method of installing the light fixture mount.

### BACKGROUND

Aligning light fixtures within the frame of the ceiling is problematic. Junction boxes and wiring are installed prior to installing drywall for the ceiling. The location of the boxes and wires is dependent on the ceiling joists because the boxes are attached to the joists. There is no reference point for the light fixture. Often, the ceiling drywall is cut prior to installation. Because there is no fiducial, there often times is a misalignment of junction boxes and precut drywall cutouts. The installation time of light fixtures is excessive and the rate of misalignment is high. Moreover, the cable management of the light fixtures is challenging.

### SUMMARY

A light fixture mount is provided. The light fixture mount includes a junction box, a cable, a plurality of screws, and a mounting plate. The mounting plate includes a circular perforation, an alignment hole, at least one slot, and a plurality of holes spaced parallel to the at least one slot. The alignment hole is centered within the circular perforation. The at least one slot is configured to receive a first shank of a first fastener. The at least one slot has a width less than a first diameter of a first head of the first fastener. The plurality of holes is configured to receive a second shank of a second fastener. The plurality of holes has a second diameter that is less than a third diameter of a second head of the second fastener. The light fixture mount is configured to position and secure a light fixture to a ceiling joist.

A method of mounting the light fixture mount is provided. The method includes positioning a mounting plate of a light fixture mount at an approximate location where the light fixture is to be mounted, positioning a laser pointer on the floor at a location directly below where the light fixture is to be placed, emitting a laser beam from the laser pointer on the mounting plate or ceiling where the light fixture is to be mounted, screwing the mounting plate into a ceiling joist through a slot in the mounting plate, adjusting the mounting plate such that the laser beam passes through an alignment hole in the mounting plate, and screwing the mounting plate to the ceiling joist through a plurality of spaced holes in the mounting plate.

### BRIEF DESCRIPTION OF THE DRAWINGS

The foregoing summary, as well as the following detailed description will be better understood when read in conjunction with the appended drawings. For the purpose of illustration, there is shown in the drawings different embodiments. It should be understood, however, that the teachings are not limited to the precise light fixture mount and method of installation shown.

FIG. 1 shows a perspective view of a light fixture mount.

FIG. 2 shows a cable.

FIG. 3 shows an open junction box.

FIG. 4 shows a top perspective view of a mounting plate.

FIG. 5 is a magnified view of the junction box coupled to the mounting plate.

FIG. 6 shows the mounting plate being aligned and secured to a ceiling joist.

FIG. 7 shows the mounted mounting plate.

FIG. 8 is a flow chart of a method of installing a light fixture mount.

### DETAILED DESCRIPTION

A light fixture mount and method of installing the light fixture mount is provided. The light fixture mount includes a junction box, a cable, and a mounting plate. The mounting plate includes a circular perforation, an alignment hole, at least one slot, and a plurality of holes spaced parallel to the at least one slot. The alignment hole is centered within the circular perforation. The at least one slot is configured to receive a first shank of a first fastener. The at least one slot has a width less than a first diameter of a first head of the first fastener. Each hole of the plurality of holes is configured to receive a second shank of a second fastener. The light fixture mount is configured to position and secure a light fixture to a ceiling joist. The light fixture mount allows for flexibility in the placement and position of light fixtures. The slot and plurality of openings in the mounting plate allow for flexibility in the lateral direction while maintaining a connection to a ceiling joist.

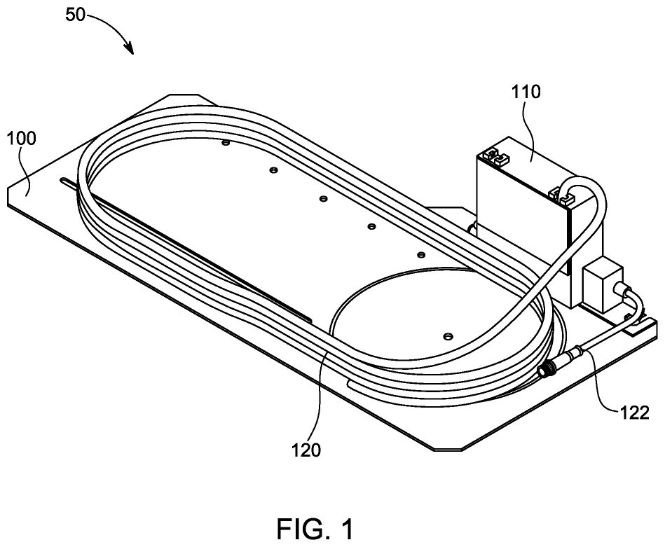

FIG. 1 shows a perspective view of a light fixture mount 50. The light fixture mount 50 includes a mounting plate 100 for a light fixture. The light fixture may be a recessed light. A junction box 110 is coupled to the mounting plate 100. A cable 120 is attached to the junction box 110 and wound onto the mounting plate 100. The junction box 110 provides electricity to the light fixture via a second cable 122.

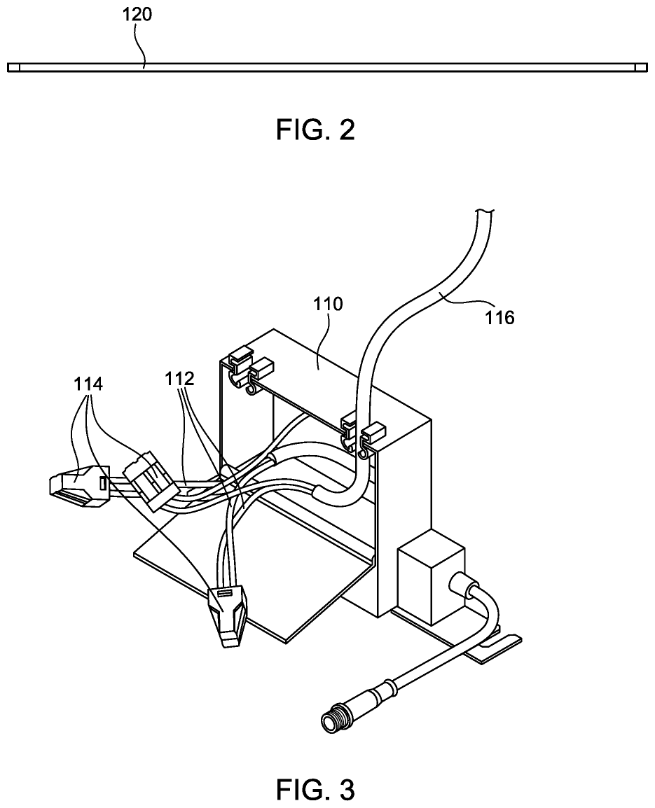

FIG. 2 shows the cable 120. The cable 120 may be an approximately 14′ long cable. The cable 120 may be labeled approximately 18″ from each end. The length of the cable 120 may be adjusted according to the distance between light fixture mounts 50 in a series of light fixtures. The cable 120 is unwound and routed to an adjacent light fixture mount 50. The routed cable 120 is then connected to cable 122 of the adjacent light fixture mount 50.

FIG. 3 shows an open junction box 110. The junction box 110 includes standard red, black, and white electrical wires 112. The black and white insulation is stripped approximately ⅜″. The stripped ends of the wire 112 are inserted into connectors 114. Exposed wire is contained in the connectors 114. Wires 112 are further encased by sheathing 116. The sheathing 116 protrudes at least ¼″ into the junction box 110. Once the connections are made, the wires 112 and connectors 114 are tucked back into the junction box 110 and the junction box 110 is closed.

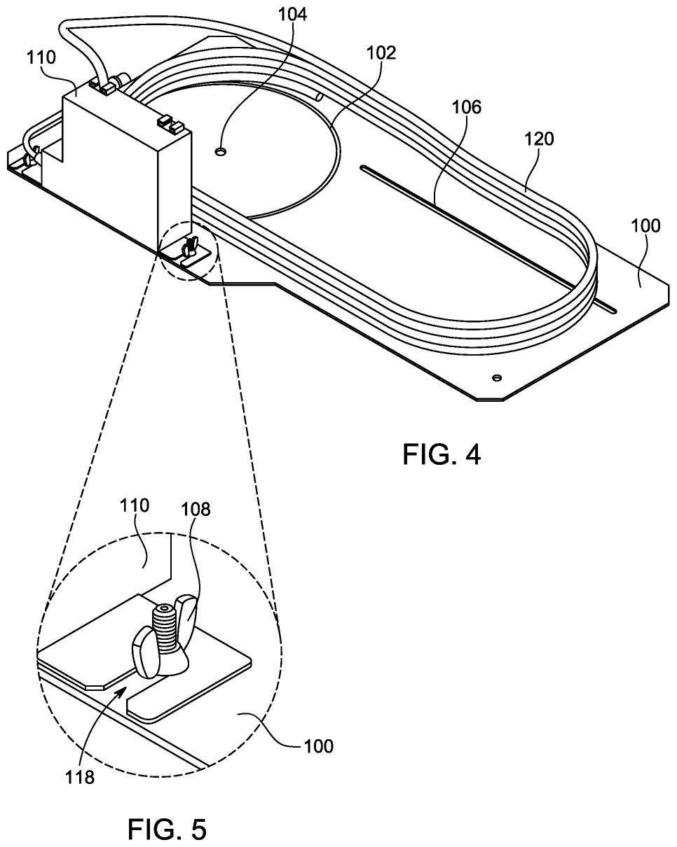

FIG. 4 shows a top perspective view of the mounting plate 100. The mounting plate 100 includes a circular perforation 102 in the mounting plate 100. An alignment hole 104 is centered within the circular perforation. The mounting plate 100 also includes at least one slot 106. The slot 106 has a width that is configured to receive a shank of a fastener. The width of the slot 106 has a width that is narrower than the head of the fastener so that the head of the fastener secures the mounting plate 100. The slot 106 may be configured to receive more than one fastener. The mounting plate 100 also includes a series of holes (not visible in FIG. 4) adjacent and parallel to the slot 106. The junction box 110 is coupled to the mounting plate 100. The junction box 110 is coupled to the mounting plate 100 so that the door of the junction box is facing the circular perforation 102.

FIG. 5 is a magnified view of the junction box 110 coupled to the mounting plate 100. The junction box 110 may be removably coupled to the mounting plate 100. The junction box 110 may be removably coupled to the mounting plate 100 to allow easy repair and maintenance of the junction box 110. As shown in FIG. 5, the junction box 110 may include at least one slot 118 that is configured to receive a fastener 108 that secures the junction box 110 to the mounting plate 100.

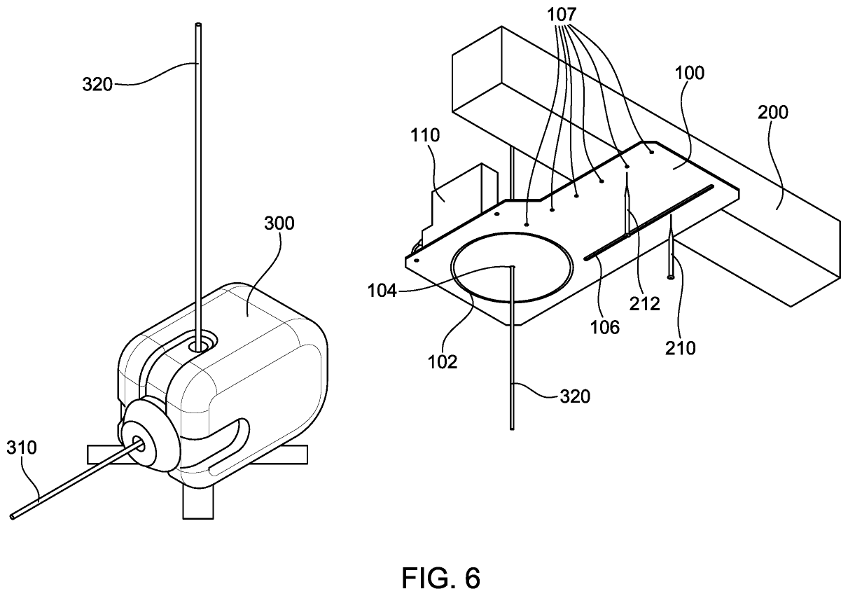

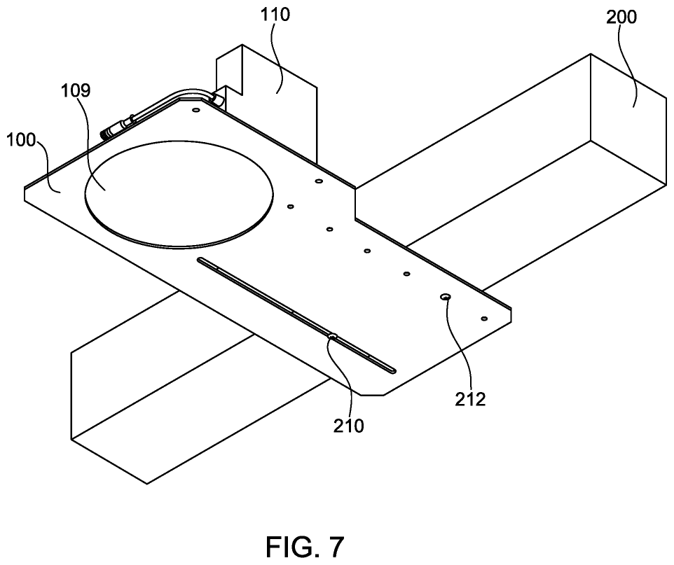

FIGS. 6-7 show the installation of the mounting plate 100 for a light fixture to a ceiling joist 200. FIG. 6 shows the mounting plate 100 being aligned to a ceiling joist 200. A laser pointer 300 is positioned on the surface of the floor below the ceiling where the light fixture is to be placed. The location of the light fixture may be marked with tape on the floor directly below the location. The laser pointer 300 is turned on. A laser beam 310 may emit parallel to the surface of the floor. The laser beam 310 ensures the placement of the laser pointer 300 is level so that the fiducial is true. Leveling the laser pointer 300 ensures that the light mount 50 placement is accurate and precise. A laser beam 320 is also emitted orthogonal to the floor and up at the ceiling where the light fixture is to be placed. The mounting plate 100 is positioned approximately where the light fixture should be placed. The mounting plate 100 is aligned based on the laser beam 320. The mounting plate 100 is secured to a ceiling joist 200 with a fastener 210 screwed, drilled, or hammered through the slot 106 in the mounting plate 100. The shank of the fastener 210 extends through the slot 106 while the head of the fastener 210, which has a larger diameter than the slot 106, secures the mounting plate 100. The slot 106 allows the mounting plate 100 to slide and rotate about the fastener 210 and the slot 106 until the laser beam 320, pointed at the ceiling, passes through the alignment hole 104. Once the mounting plate 100 is aligned according to the laser beam 320, at least one fastener 212 is screwed, drilled, or hammered through a hole 107 of the series of holes 107. Fasteners may be inserted in more than one hole 107 to secure the mounting plate 100 to the ceiling joist 200.

FIG. 7 shows the mounted mounting plate 100. After the mounting plate 100 is mounted, the circular perforation may be completely cut and the circular portion is removed leaving an opening 109 in the mounting plate 100. The light fixture can then be placed and secured to the mounting plate 100 and connected to the junction box 110. The light fixture extends through the opening 109 in the mounting plate 100. The cable 120 of the first light is landed into the junction box 110 via cable 122 of the next light fixture in a series of light fixtures. This connection electrically connects a series of light mounts 50 and lights fixtures. For example, recessed lights in a room may all be electrically connected.

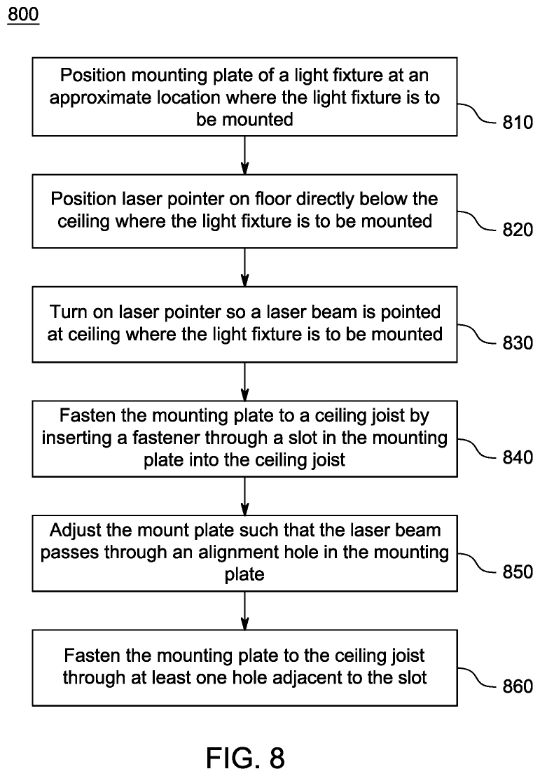

FIG. 8 is a flow chart of a method of installing a light fixture mount 800. The light fixture mount 50 includes the same details and embodiments described above. In step 810, the mounting plate 100 is positioned at an approximate location where the light fixture is to be mounted. In step 820, a laser pointer 300 may be positioned on a floor directly below where a light fixture is to be mounted according to design plans. In step 830, the laser pointer 300 may be turned on. A laser beam 310 may be emitted orthogonally to the surface of the floor. A laser beam 320 may be emitted up at the ceiling where the light fixture should be mounted. In step 840, the mounting plate 100 is fastened to the ceiling joist 200 close to where the light fixture is to be placed. The mounting plate 100 is fastened to the ceiling by screwing, drilling, or hammering a fastener through the slot 106 in the mounting plate 100 into the ceiling joist 200. In step 850, the mounting plate 100 is adjusted such that the laser beam 320 passes through an alignment hole 104 in the mounting plate 100. In step 860, the mounting plate 100 is fastened to the ceiling joist 200 via at least one fastener being drilled, screwed, or hammered through at least one hole 107 in the mounting plate 100. The method 800 may further include removing the perforated circular portion from the mounting plate 100, installing ceiling drywall, securing the light fixture to the mounting plate 100 and connecting the light fixture to the junction box 110.

Having thus described in detail a preferred selection of embodiments of the present invention, it is to be appreciated and will be apparent to those skilled in the art that many physical changes could be made to the light fixture mounting plate and method of mounting without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. A light fixture mount comprising:
a mounting plate including at least one slot, a plurality of openings adjacent to and parallel to the at least one slot, and a perforated circular portion, the perforated circular portion including an alignment hole in an approximate center of the perforated circular portion;
a junction box attached to the mounting plates; and
a cable connected to the junction box.

2. The light fixture mount of claim 1 wherein the junction box includes a plurality of wires connected to connectors.

3. The light fixture mount of claim 1 wherein the junction box includes a door.

4. The light fixture mount of claim 3 wherein the junction box is positioned on the mounting plate so that the door of the junction box faces towards the perforated circular portion.

5. The light fixture mount of claim 1 wherein the perforated circular portion is configured to be removed to leave an opening in the mounting plate.

6. The light fixture mount of claim 5 further including a light fixture extending through the opening in the mounting plate and secured to the mounting plate.

7. The light fixture mount of claim 1 wherein the mounting plate is configured to secure to a ceiling joist via at least one first fastener through the slot and at least one second fastener through the at least one opening of the plurality of openings.

8. A method of installing a light fixture mount comprising:
receiving the light fixture mount, the light fixture mount including a mounting plate including at least one slot, a plurality of openings adjacent to and parallel to the at least one slot, and a perforated circular portion, the perforated circular portion including an alignment hole in an approximate center of the perforated circular portion; a junction box attached to the mounting plates, and a cable connected to the junction box;
positioning a laser pointer on a floor directly under a ceiling where a light fixture is to be mounted;
fastening the mounting plate to a ceiling joist with a first fastener through the slot at an approximate location of where the light fixture is to be mounted;
adjusting the mounting plate until the laser pointer passes a laser through the alignment hole in the mounting plate; and
fastening the adjusted mounting plate to the ceiling joist with a second fastener through an opening of the plurality of openings in the mounting plate.

9. The method of claim 8 wherein the junction box includes a plurality of wires connected to connectors.

10. The method of claim 8 wherein the junction box includes a door.

11. The method of claim 10 wherein the junction box is positioned on the mounting plate so that the door of the junction box faces towards the perforated circular portion.

12. The method of claim 8 wherein the perforated circular portion is configured to be removed to leave an opening in the mounting plate.

13. The method of claim 12 further including a light fixture extending through the opening in the mounting plate and secured to the mounting plate.

14. The method of claim 8 wherein the mounting plate is configured to secure to a ceiling joist via at least one first fastener through the slot and at least one second fastener through the at least one opening of the plurality of openings.

15. The method of claim 8 further including securing a light fixture to the mounting plate.

16. The method of claim 15 further including connecting the light fixture to the junction box.
